(19) United States
(12) Patent Application Publication
(10) Pub. No.: US 2010/0208592 A1
(43) Pub. Date: Aug. 19, 2010

(54) PACKET PROCESSING APPARATUS AND COMMUNICATION DEVICE

(75) Inventors: Naoki MATSUOKA, Kawasaki (JP); Jun Tanaka, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 12/707,251

(22) Filed: Feb. 17, 2010

(30) Foreign Application Priority Data
Feb. 19, 2009 (JP) 2009-036842

(51) Int. Cl. H04L 12/56; H04L 12/26

(52) U.S. Cl. 370/241; 370/412

(57) ABSTRACT

A packet processing apparatus for receiving incoming packets transmitted from any of the other apparatuses, processing the incoming packets and transmitting the processed packets to any of the other apparatuses, includes a buffer for temporarily storing the incoming packets; a processing unit for processing the incoming packets stored in the buffer and transmitting the processed packets to any of the other apparatuses; and a mode controller for controlling an operation mode of the processing unit, wherein when the mode controller is to change the operation mode of the processing unit, the mode controller generates a request for suspension of transmitting incoming packets to the any of the other apparatuses, confirms that the processing unit has completed processing of all the incoming packets stored in the buffer, changes the operation mode of the processing unit, and generates a request for resume of transmitting incoming packets to the any other apparatuses.

### CROSS-REFERENCE TO RELATED APPLICATION

This application is based upon and claims the benefit of priority of the prior Japanese Patent Application No. 2009-036842, filed on Feb. 19, 2009, the entire contents of which are incorporated herein by reference.

### FIELD

The embodiments discussed herein are related to a packet processing apparatus and a communication device.

### BACKGROUND

As is known, because Internet traffic occurs on a very intermittent basis, the average link usage rates of communication devices are relatively low. However, when a large amount of data traffic momentarily occurs, the link usage rates amount to nearly 100%. Many of communication devices, therefore, are operating so as to always meet the proceeding performance at respective link speeds in order to be capable of addressing a large amount of data traffic. As a result, high powers are always being consumed even during low traffic states.

Conventional power reduction methods include a method wherein, when a load is low, the operation clock frequency of an LSI is dynamically reduced (refer to, for example, Japanese Laid-open Patent Publication No. 8-6681), and a method wherein several steps of operation processing speeds are prepared in advance, and the operation mode of a communication device is statically switched in response to a traffic amount flowing in a network (refer to, for example, Alaxala Networks Cooperation: Internet (URL: http://www.alaxala.com/jp/solution/solution/measures/index.html)). In general, the power consumption of the LSI increases in proportion to the operation clock frequency. It is, therefore, desirable to lower the operation clock frequency to thereby reduce the power consumption of communication device.

However, in Japanese Laid-open Patent Publication No. 8-6681, the operation clock frequency of the LSI has been changed in response to a load irrespective of communication states, states inside a system, etc. In this case, even in a state wherein traffic is flowing, or wherein packets remain in the communication system, the operation clock frequency of the LSI is changed. As a result, as illustrated in FIG. 1A, during a clock stabilization period of time from when the operation clock frequency is changed until when the operation clock frequency is stabilized, newly-arrived packets and the like are discarded or disappear. This has raised a problem of affecting communication quality.

On the other hand, in Alaxala Networks Cooperation: Internet (URL: http://www.alaxala.com/jp/solution/solution/measures/index.html), a communication device is reactivated in changing the operating mode. As a result, as illustrated in FIG. 1B, there has occurred a problem in that communication services are interrupted during a device reactivation period until the communication device is reactivated.

In this way, in the related arts, when changing the operating mode, the degradation of communication quality or the interruption of communication services have undesirably taken place, which has made it difficult to change the communication mode in a network, wherein a great importance is placed on the communication quality. Hitherto, therefore, even in low traffic states, the communication device has operates at full speed at all times, so that high powers have continued to be consumed.

### SUMMARY

According to an aspect of the invention, a packet processing apparatus for receiving a plurality of incoming packets transmitted from any of the other apparatuses, processing the incoming packets and transmitting the processed packets to any of the other apparatuses, includes a buffer for temporarily storing the incoming packets; a processing unit for processing the incoming packets stored in the buffer and transmitting the processed packets to any of the other apparatuses; and a mode controller for controlling an operation mode of the processing unit, wherein when the mode controller is to change the operation mode of the processing unit, the mode controller generates a request for suspension of transmitting incoming packets to the any of the other apparatuses, confirms that the processing unit has completed processing of all the incoming packets stored in the buffer, changes the operation mode of the processing unit, and generates a request for resume of transmitting incoming packets to the any other apparatuses.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIGS. 1A and 1B are diagrams explaining problems in the related arts 1 and 2;

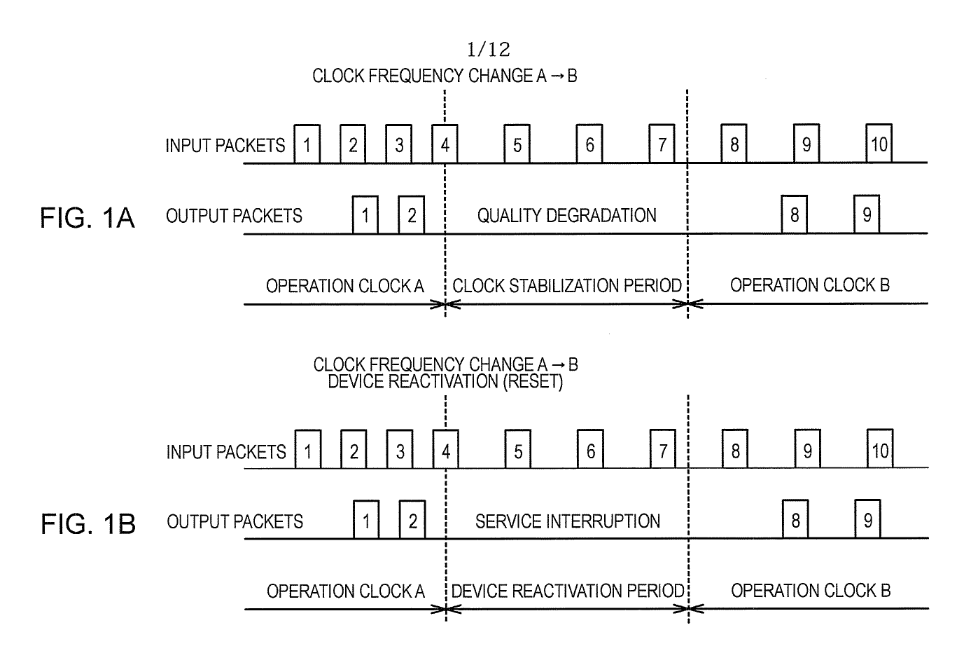

FIG. 2 is a block diagram explaining a packet processing apparatus disclosed in the present description;

FIG. 3 is a schematic diagram explaining the configuration of a packet processing portion;

FIG. 4 is a diagram explaining the configuration of a communication device according to a first embodiment;

FIG. 5 is a function block diagram of the packet processing apparatus provided in a line card output portion;

FIG. 6 is a diagram illustrating an operation flowchart of the packet processing apparatus;

FIG. 7 is a diagram explaining the operation sequence of the packet processing apparatus;

FIGS. 8A to 8C are diagrams explaining transmission modes of back pressure information such as output line card information, packet delivery stop instruction, and packet delivery restart instruction;

FIG. 9 is a block diagram explaining a packet processing apparatus according to a second embodiment;

FIG. 10 is a diagram explaining a packet processing apparatus according to a third embodiment;

FIGS. 11A and 11B are diagrams explaining PAUSE frame based on IEEE 802.3X; and

FIGS. 12A and 12B are diagrams explaining operation examples in the case wherein, when the operation mode of an output packet processing portion of a communication device A is changed, the operation mode of an input side packet processing portion of a post-stage communication device C is also changed together.

### DESCRIPTION OF EMBODIMENTS

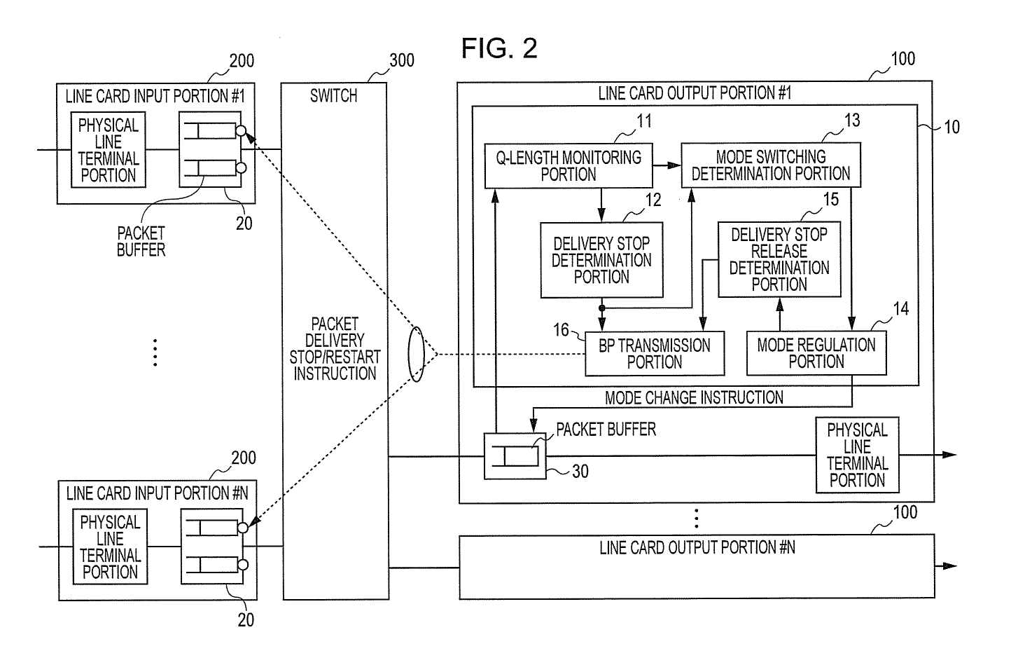

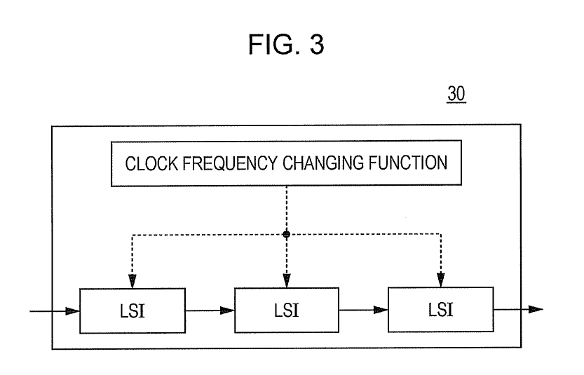

FIG. 2 is a block diagram explaining a packet processing apparatus disclosed in the present description. FIG. 3 is a schematic diagram explaining the configuration of a packet processing portion 30 to be described later.

The packet processing apparatus includes at least a packet buffer for temporarily storing the incoming packets, a packet processing unit for processing the incoming packets stored in the packet buffer and transmitting the processed packets to any of the other apparatuses, and a mode controller. As described in FIG. 2, the operation mode changing device (mode controller) 10 is provided in a line card output portion 100 connected to a line card input portion 200 via a switch 300. The line card input portion 200 functions as an input port, while the line card output portion 100 functions as an output port. A packet delivered from a packet processing portion 20 of the line card input portion 200 is inputted into the packet processing portion (processing unit) 30 in the line card output portion 100 via the switch 300.

As illustrated in FIG. 3, the packet processing portion 30 is configured to have a plurality of LSIs. The packet processing portion 30 has a function of changing its own clock frequency in accordance with an instruction from an external device.

Hereinafter, details on the operation mode changing device 10 will be described. The operation mode changing device 10 includes a Q-length monitoring portion 11, a delivery stop determination portion 12, a mode switching determination portion 13, a mode regulation portion 14, a delivery stop release determination portion 15, and a back pressure (BP) transmission portion 16.

The Q-length monitoring portion 11 derives an average Q (queue) length of a packet buffer in the packet processing portion 30 provided in the line card output portion 100. On the basis of the average Q-length derived in the Q-length monitoring portion 11, the delivery stop determination portion 12 determines the necessity/unnecessity of an operation mode change of the packet processing portion 30. For example, if the average Q-length is not less than a predetermined value or not more than the predetermined value, the delivery stop determination portion 12 determines that an operation mode change is “needed”. The delivery stop determination portion 12, upon determining that the operation mode change is “needed”, instructs the BP transmission portion 16 to stop the packet delivery of the packet processing portion 20 in the line card input portion 200.

The BP transmission portion 16, upon receipt of the packet delivery stop instruction from the delivery stop determination portion 12, transmits the packet delivery stop instruction to the packet processing portion 20. This results in stoppage of flow of packets from the packet processing portion 20 into the packet processing portion 30. By this control, after a predetermined time period has been elapsed, all packets within the packet buffer in the packet processing portion 30 are delivered. Consequently, the packet buffer in the packet processing portion 30 becomes empty.

The mode switching determination portion 13 determines whether the packet processing portion 20 has stopped the packet delivery and also whether the packet buffer of the packet processing portion 30 has become empty. When it has been determined that the packet processing portion 20 has stopped the packet delivery and that the packet buffer of the packet processing portion 30 has become empty, the mode switching determination portion 13 transmits a mode change instruction to the mode regulation portion 14. In this case, the mode switching determination portion 13 instructs to switch the operation mode to a higher speed operation mode if the average Q-length is not less than the predetermined value, while switch the operation mode to a lower speed operation mode if the average Q-length is not more than the predetermined value.

The mode regulation portion 14 changes the operation mode of the packet processing portion 30 in accordance with the instruction from the mode switching determination portion 13. The delivery stop release determination portion 15 determines whether the operation mode of the packet processing portion 30 has reached a steady state. The delivery stop release determination portion 15, when having determined that the operation mode of the packet processing portion 30 has reached a steady state, instructs the BP transmission portion 16 to release the stoppage of the packet delivery of the packet processing portion 20. The BP transmission portion 16, upon receipt of the instruction for the packet delivery stop release from the delivery stop determination portion 12, transmits a packet delivery restart instruction to the packet processing portion 20. This results in the restart of flow of packets from the packet processing portion 20 into the packet processing portion 30.

According to the present configuration, during a time period from the point in time when the operation mode of the packet processing portion 30 actually begins to be changed until the operation mode of the packet processing portion 30 becomes stabilized, the packet processing portion 20 is in a non-communication state. In this case, packet loss due to the operation mode change does not occur. This allows avoiding communication quality degradation to occur when operation mode is changed. Furthermore, as compared with the case wherein the device is reactivated in changing the operation mode, the time period for changing operation mode is very short. This enables avoidance of long-period service interruption. Also, if the average Q-length is not more than the predetermined value, the drive clock frequency of the packet processing portion 30 is lower, resulting in reduced power consumption.

In the configuration in FIG. 2, the packet processing portion 20 functions as a pre-stage packet processing section; the Q-length monitoring portion 11, the delivery stop determination portion 12, and the BP transmission portion 16 function as a delivery stop instruction section; the packet processing portion 30 functions as a self-packet processing section; the mode switching determination portion 13 and the mode regulation portion 14 function as a mode changing section; and the delivery stop release determination portion 15 and the BP transmission portion 16 function as a delivery restart instruction section.

### First Embodiment

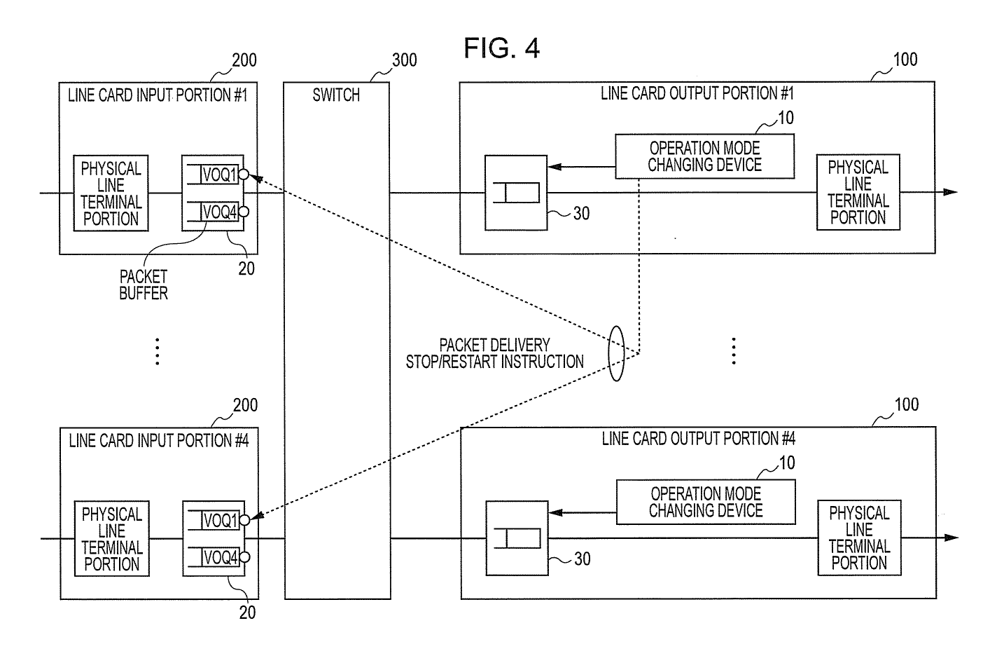

FIG. 4 is a diagram explaining the configuration of a communication device according to a first embodiment. The communication device according to the first embodiment is, for example, Ethernet® switch, which is configured so that four (#1 to #4) line card input portions 200 are connected to four (#1 to #4) line card output portions 100 via the switch 300.

Each of the line card input portions 200 functions as an input port, and has the packet processing portion 20 including four packet buffers (virtual output queues: VOQs) corresponding to the #1 to #4 line card input portions 100. The packet processing portion 20 analyses the header of an arrived IP packet or that of a frame of the Ethernet®, and performs forwarding processing for determining a destination line card and packet buffering processing.

Each of the line card output portions 100 has the packet processing portions 30 each having a packet buffer, and performs priority control as well as QoS control such as traffic shaping. The packet buffers of the packet processing portions 30 may have queues for each quality class or each VLAN.

It is assumed that the drive mode of the packet processing portion 30 in the #1 line card output portion 100 is changed by the operation mode changing device 10 into several steps. For example, it is assumed that the packet processing portion 30 can be operated by drive clocks at five steps: 1 GHz, 800 MHz, 600 MHz, 400 MHz, and 200 MHz, and that the packet processing portion 30 is performing packet processing at the maximum drive mode (1 GHz). Hereinafter, description will be made of operation examples in the case wherein the traffic amount has decreased from that in the above-described state with the passage of time.

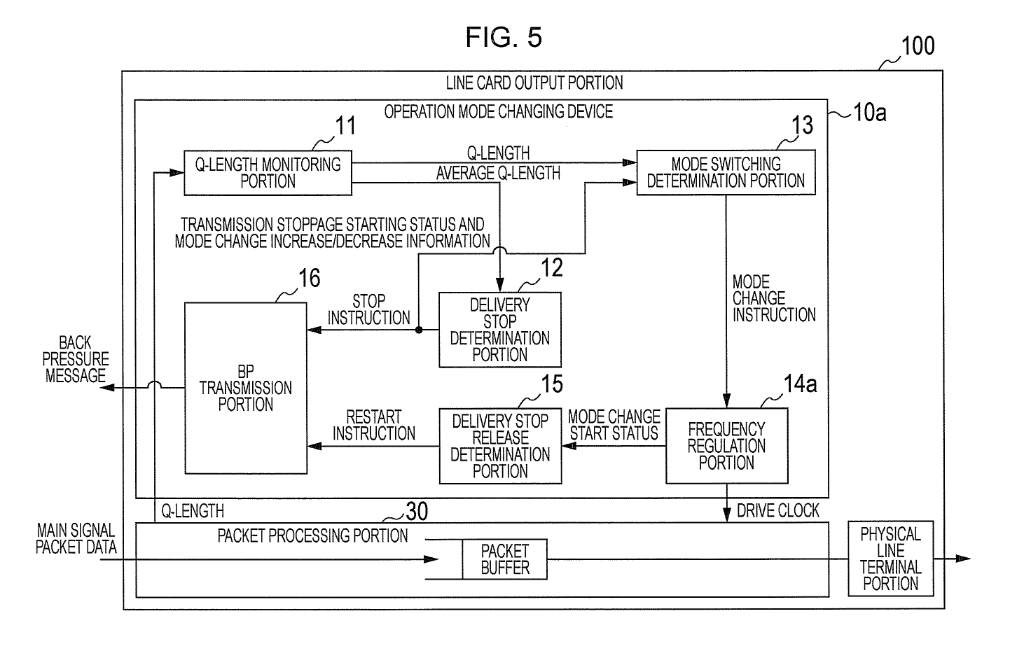

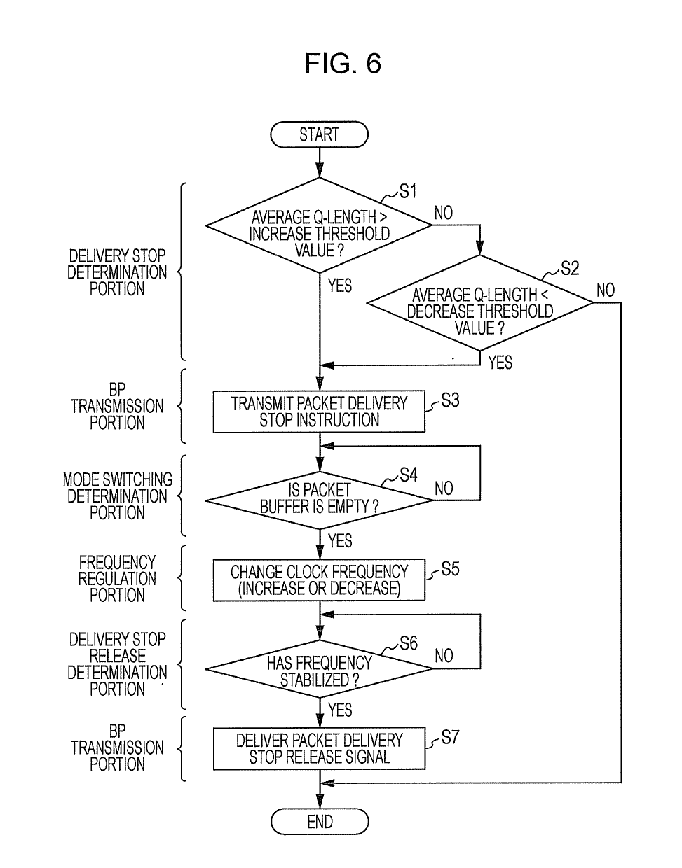

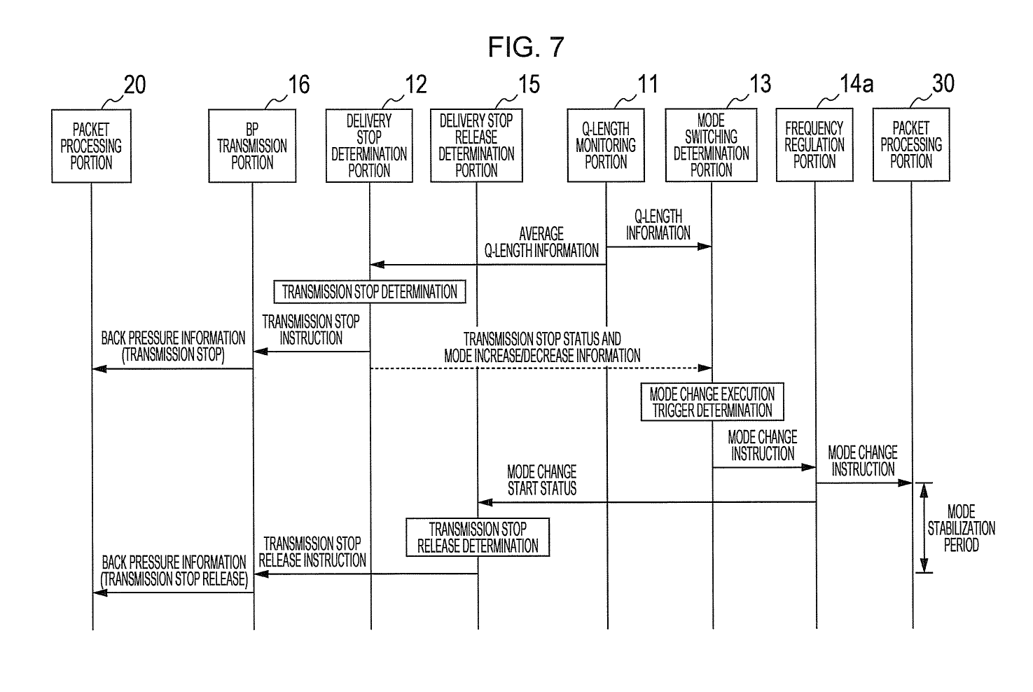

FIG. 5 is a function block diagram of the packet processing apparatus provided in the #1 line card output portion 100. FIG. 6 is a diagram illustrating an operation flowchart of the packet processing apparatus. FIG. 7 is a diagram explaining an operation sequence of the packet processing apparatus. Here, the difference of the operation mode changing device 10a from the operation mode changing device 10 in FIG. 2 lies in that the operation mode changing device 10a has a frequency regulation portion 14a instead of the mode regulation portion 14.

The Q-length monitoring portion 11 manages the current Q-length of the packet processing portion 30 and its average Q-length, which is an average value of temporally varying Q-length. The Q-length monitoring portion 11 supplies the Q-length and the average Q-length to the delivery stop determination portion 12 and the mode switching determination portion 13.

The delivery stop determination portion 12 determines whether the average Q-length value supplied from the Q-length monitoring portion 11 is not less than the clock frequency increase threshold value (step S1). If the determination in step 1 is “No”, the delivery stop determination portion 12 determines whether the average Q-length value is not more than the clock frequency decrease threshold value (step S2).

If the determination in either step 1 or step 2 is “Yes”, the delivery stop determination portion 12 transmits a delivery stop instruction to the packet processing portion 20 in each of the line card input portions 200. For example, when the traffic amount is low, the average Q-length value is small, so that the average Q-length becomes not more than the clock frequency decrease threshold value. On the other hand, when the traffic amount is high, the average Q-length value is large, so that the average Q-length becomes not less than the clock frequency increase threshold value. The delivery stop determination portion 12, upon detecting that the average Q-length is not more than the clock frequency decrease threshold value or not less than the clock frequency increase threshold value, transmits a delivery stop instruction message (STOP instruction) to the BP transmission portion 16. As a consequence, the BP transmission portion 16 transmits, to the packet processing portion 20 in each of the line card input portions 200, a back pressure message including a packet delivery stop instruction to the #1 line card output portion 100 (step S3).

The packet processing portion 20, upon receipt of the back pressure message, stops packet delivery to the #1 line card output portion 100. Consequently, no packet flows from each of the line card input portions 200 into the #1 line card output portion 100. However, even though the packet delivery to the #1 line card output portion 100 is stopped, packet deliveries to the other line card output portions are possible. Therefore, communication quality degradation due to “head of line” blocking does not occur.

On the other hand, the packet processing portion 30 in the #1 line card output portion 100 is continuing to process packets remaining in the packet buffer, using the current clock frequency. Upon elapse of some period of time after the packet delivery has been stopped, all remaining packets in the packet processing portion 20 are outputted, thus empting the packet buffer.

The mode switching determination portion 13 determines whether the packet buffer of the packet processing portion 30 after the stoppage of the packet delivery of the packet processing portion 20 in each of the line card input portions 200, has become empty (step S4). If the determination in step S4 is “No”, the mode switching determination portion 13 executes again step S4. On the other hand, if the determination in step S4 is “Yes”, the mode switching determination portion 13 provides the frequency regulation portion 14a with an operation mode change instruction including clock increase/decrease information.

This clock increase/decrease information is results of threshold value determinations by the delivery stop determination portion 12. If the average Q-length has become not more than the clock decrease threshold value, the mode switching determination portion 13 notifies the frequency regulation portion 14a of a mode change instruction indicating that the clock frequency of the packet processing portion 30 is lowered by one step (step S5). The frequency regulation portion 14a, upon receipt of this notification, lowers the operation mode of the packet processing portion 30 by one step from the current operation mode (1 GHz), and supplies the packet processing portion 30 with a drive clock signal at 800 MHz. On the other hand, if the average Q-length has become not less than the clock increase threshold value, the mode switching determination portion 13 notifies the frequency regulation portion 14a of a mode change instruction indicating that the clock frequency of the packet processing portion 30 is raised by one step (step S5).

The packet processing portion 30 starts an operation by a new drive clock supplied from the frequency regulation portion 14a. Generally, in circuitry such as an LSI, when its clock frequency is changed, operation of the circuitry is not guaranteed until the clock frequency stabilizes. Accordingly, the delivery stop release determination portion 15 determines whether the clock frequency of the packet processing portion 30 has stabilized (step S6). If the determination in step S6 is “No”, the delivery stop release determination portion 15 executes again step S6.

Here, the delivery stop release determination portion 15 may determine that the clock frequency has not stabilized until a predetermined time elapses after it has received a mode change start status indicating that the frequency regulation portion 14a has changed the operation mode. The above-described predetermined time is, for example, a time period from the point in time when the packet processing portion 30 receives a new clock until the time when the packet processing portion 30 enters a state capable of performing a normal operation in a stable manner.

If the determination in step S6 is “Yes”, the delivery stop release determination portion 15 provides the BP transmission portion 16 with a delivery stop release instruction (RESTART instruction) to release the stoppage of the packet delivery of the packet processing portion 20 in each of the line card input portions 200. As a result, the BP transmission portion 16 transmits, to the packet processing portion 20 in each of the line card input portions 200, a back pressure message including an instruction to release the stoppage of the packet delivery to the #1 line card output portion 100 (step S7). Thereby, packet transfers from each of the line card input portions 200 to #1 line card output portion 100 is restarted.

In this manner, packet processing of the packet processing portion 30 does not occur until the drive clock frequency stabilizes and the packet processing portion 30 becomes capable of a stable operation after the change in the drive clock frequency of the packet processing portion 30. In this case, no packet discard occurs when the drive clock frequency is changed. This allows changing the operation mode while inhibiting the degradation of communication quality, and further, enables switching the operation mode in response to a traffic amount. Consequently, the operation mode can be switched in a fine-tuned manner as compared with operation mode methods involving the reactivation of a device. This makes it possible to reduce power consumption of the communication in response to traffic variations.

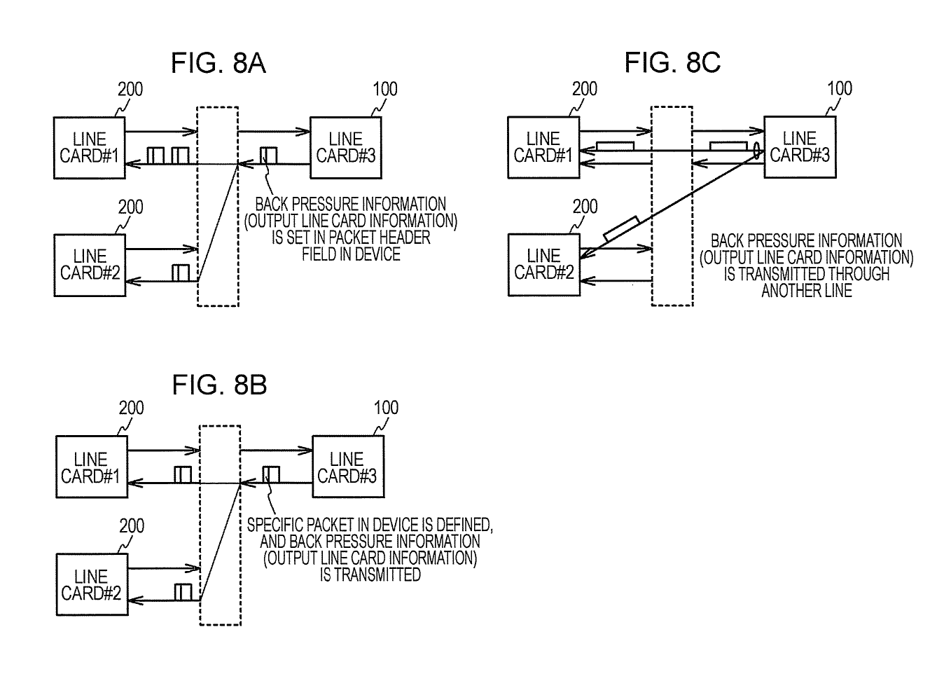

FIGS. 8A to 8C are diagrams explaining transmission modes of back pressure information to be transmitted from the BP transmission portion 16 to the packet processing portion 20, such as output line card information, a packet delivery stop instruction, and a packet delivery restart instruction. For example, as illustrated in FIG. 8A, the BP transmission portion 16 may set back pressure information in the packet header in the device to thereby transmit the back pressure information along with a main signal packet. As illustrated in FIG. 8B, the BP transmission portion 16 may define back pressure packets in the device to thereby transmit them individually. Also, as illustrated in FIG. 8C, the BP transmission portion 16 may transmit the back pressure packets through lines other than those for the main signals.

The Q-length monitoring portion 11 may determine the average Q-length from Q-length information acquired at a fixed time interval. Alternatively, in order to monitor long-term load, the Q-length monitoring portion 11 may calculate the average Q-length on a weighted average basis by weighting past Q-length information. Still alternatively, instead of estimating load from the average Q-length, the Q-length monitoring portion 11 may monitor the amount of packets arriving at the input portion of the packet processing portion, and when the amount has become more than a fixed value or less than the fixed value, the Q-length monitoring portion 11 may switch the operation mode.

In the present embodiment, the packet processing portion 20 functions as a pre-stage packet processing section; the Q-length monitoring portion 11, the delivery stop determination portion 12, and the BP transmission portion 16 function as a delivery stop instruction section; the packet processing portion 30 functions as a self-packet processing section; the mode switching determination portion 13 and the frequency regulation portion 14a function as a mode changing section; and the delivery stop release determination portion 15 and the BP transmission portion 16 function as a delivery restart instruction section.

### Second Embodiment

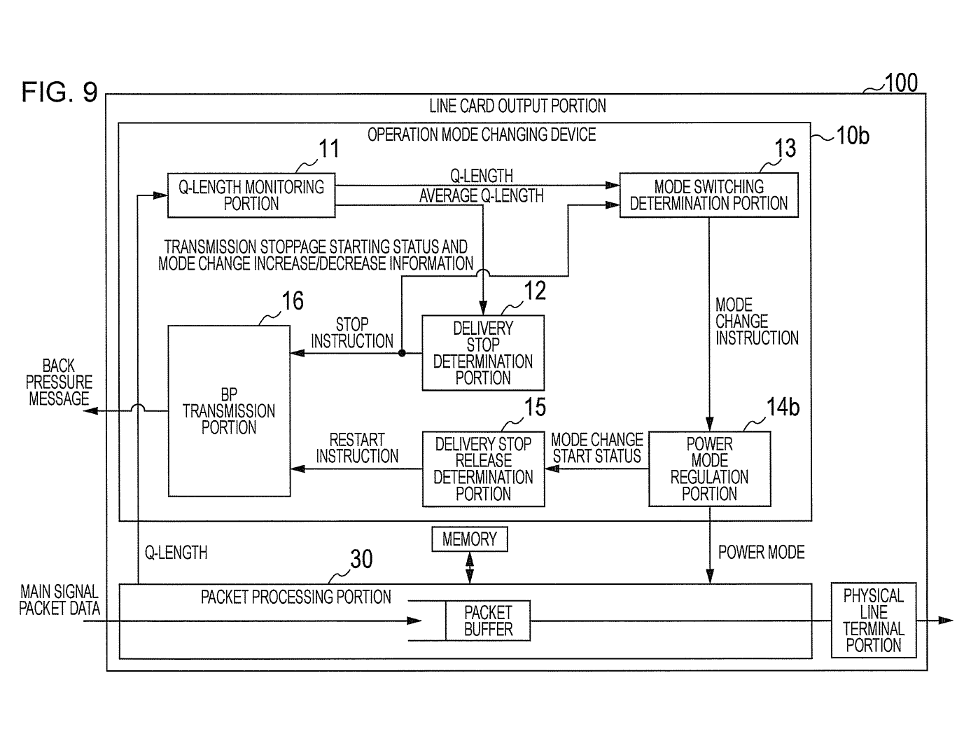

In general, a network processor, FPGA, ASIC, and memories externally connected thereto that perform packet processing each have power save mode wherein the throughput is lowered to reduce power consumption. In the second embodiment, therefore, the power mode of the packet processing portion 30 is switched on the basis of the average Q-length. FIG. 9 is a block diagram explaining a packet processing apparatus according to a second embodiment. The operation mode changing device 10b has a power mode regulation portion 14b instead of the clock frequency regulation portion 14a.

When traffic amount decreases and eventually the average Q-length has become not more than a power saving mode threshold value (which is equivalent to the clock decrease threshold value in the first embodiment), the delivery stop determination portion 12 stops the packet delivery of the packet processing portion 20 via the BP transmission portion 16. Thereafter, when the packet buffer of the packet processing portion 30 becomes empty, the delivery stop determination portion 12 instructs, via the mode switching determination portion 13, the power mode regulation portion 14b to shift to the power saving mode. Upon receipt of this instruction, the power mode regulation portion 14b performs setting such that the network processor, the FPGA, the ASIC, and the external devices, such as memories, connected thereto, operate in the power saving mode. Alternatively, the power mode regulation portion 14b may also provide a power saving mode instruction to the network processor, the FPGA, and the ASIC so that the network processor, FPGA, ASIC, and the external devices operate in the power saving mode.

Also in the present embodiment, the delivery stop release determination portion 15, upon waiting until the operation of the packet processing portion 30 stabilizes after having been switched to the power saving mode, provides a delivery stop release instruction to the BP transmission portion 16. Thereby, the BP transmission portion 16 transmits a delivery stop release instruction to the packet processing portion 20.

According to this embodiment, the power consumption of a communication device can be reduced in response to the decrease of traffic amount. The delivery stop determination portion 12, when traffic amount increases until the average Q-length has become not less than the power saving mode threshold value (which is equivalent to the clock increase threshold value in the first embodiment), stops the packet delivery of the packet processing portion 20 via the BP transmission portion 16. Thereafter, when the packet buffer of the packet processing portion 30 has become empty, the delivery stop determination portion 12 instructs, via the mode switching determination portion 13, the power mode regulation portion 14b to shift to the normal operation mode. Thus it is possible to change the operation mode of the packet processing portion in response to traffic variations.

The operation mode changing device 10b may have both the frequency regulation portion 14a and the power mode regulation portion 14b. By doing so, it is possible to more suppress power consumption.

In this embodiment, the Q-length monitoring portion 11, the delivery stop determination portion 12, and the BP transmission portion 16 function as a delivery stop instruction section; the mode switching determination portion 13 and the mode regulation portion 14 function as a mode changing section; and the delivery stop release determination portion 15 and the BP transmission portion 16 function as a delivery restart instruction section.

### Third Embodiment

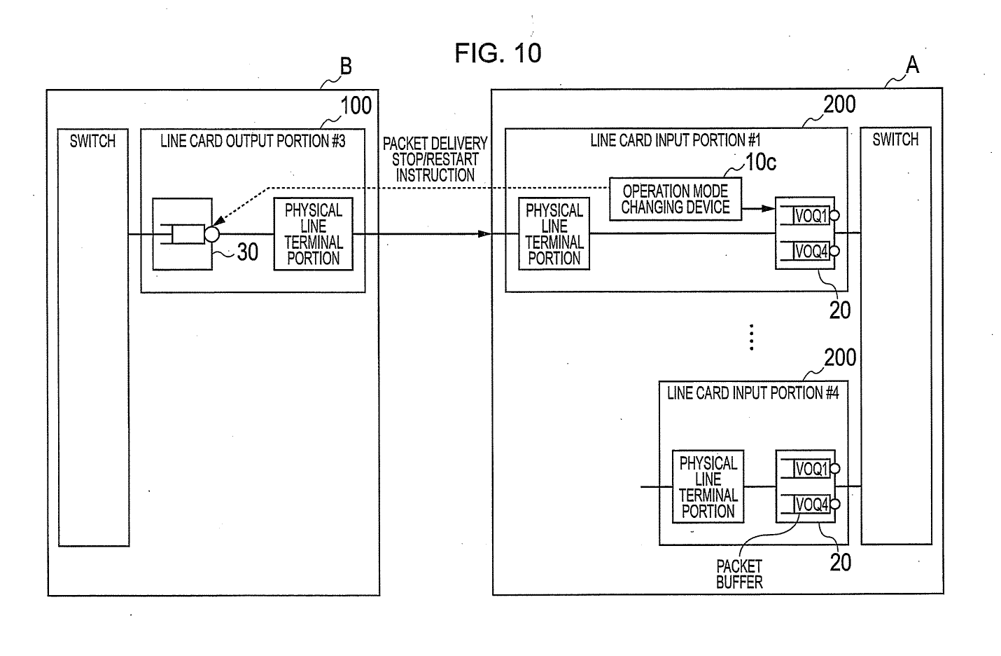

Next, description will be made of a packet processing apparatus including an operation mode changing device 10c for changing the operation mode of the packet processing portion 20 in the line card input portion 200. FIG. 10 is a diagram explaining the packet processing apparatus including an operation mode changing device 10c.

The operation mode changing device 10c is provided in the line card input portion 200 of the communication device A. The configuration of the operation mode changing device 10c either may be the same as that of the operation mode changing device 10a according to the first embodiment, or may be the same as that of the operation mode changing device 10b according to the second embodiment.

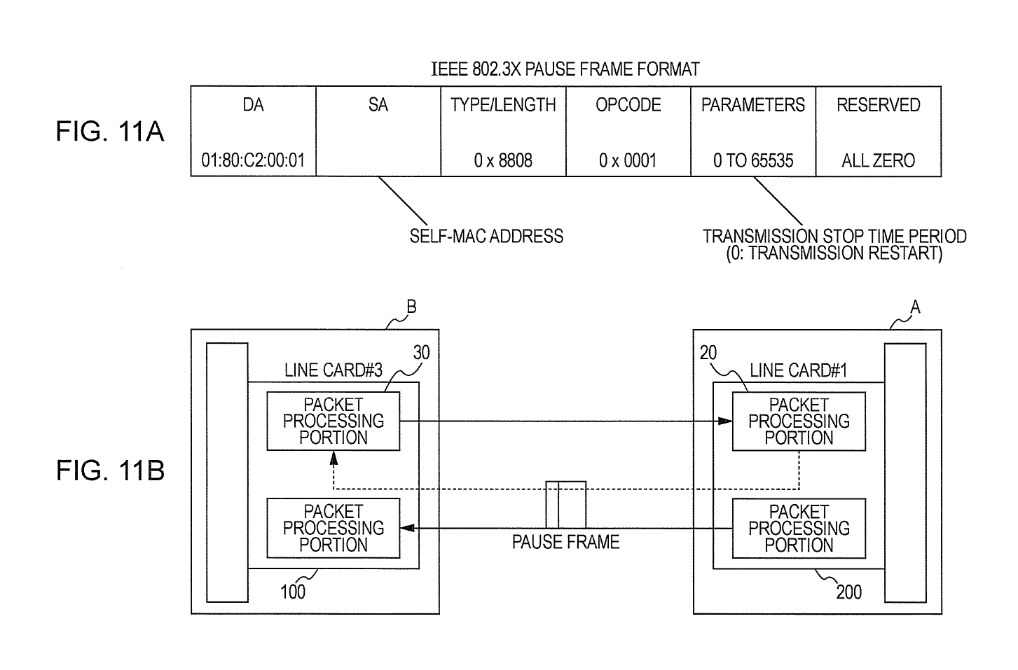

The operation mode changing device 10c determines, in the Q-length monitoring portion 11, the average Q-length from the sum total of Q-lengths of all packet buffers of the packet processing portions 30 in the line card output portion 100 in the communication device B. Operations of the operation mode changing device 10c are the same as those of the operation mode changing devices 10a and 10b. The BP transmission portion 16, when stopping the packet delivery from the packet processing portion 30, employs IEEE 802.3X-based PAUSE frame in FIG. 11B.

According to this embodiment, when the operation mode of the packet processing portion in the input port is changed, it is possible to avoid packet loss and the occurrence of service interruption, and to maintain communication quality.

In this embodiment, the communication device B functions as a pre-stage communication device.

In the above-described embodiments, necessity/unnecessity of the change of operation mode of the self-packet processing section has been determined on the basis of the average Q-length, but the determination of the necessity/unnecessity is not limited to this method. For instance, the necessity/unnecessity of the change of operation mode may be determined on the basis of the traffic average load inputted to the self-packet processing section. By way of example, the operation mode of the self-packet processing section may be changed into a higher speed mode when the traffic average load has become not less than a threshold value, while the operation mode of the self-packet processing section may be changed into a lower speed mode when the traffic average load has become not more than the threshold value.

### Fourth Embodiment

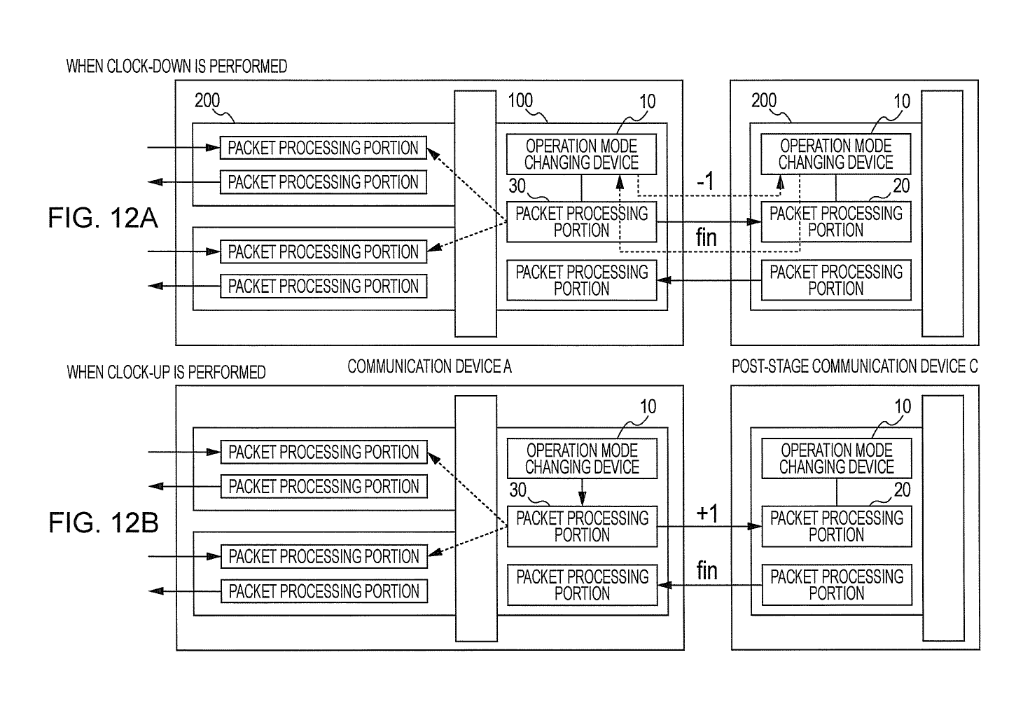

In the first to third embodiments, the operation mode of the processing portion in the self-communication device has been determined, but the operation mode of the post-stage communication device that receives packets from the self-communication device may be changed together. FIGS. 12A and 12B are diagrams each explaining an operation example in the case wherein, when the operation mode of output packet processing portions of the communication device A is changed, the operation mode of input side packet processing portions of a post-stage communication device C is also changed together.

The operation mode changing device 10 of the communication device A stops the packet delivery of the input-side packet processing portion, prior to changing the operation mode of the packet processing portion 30 in the line card output portion 100. Thereafter, when the packet buffer in the packet processing portion has become empty, the operation mode changing device 10 of the communication device A changes the operation mode of the packet processing portion.

Thereafter, the communication device A transmits, to the packet processing portion 20 in the line card input portion 200 of the post-stage communication device C, an operation mode change notification packet including information indicating that the operation mode is changed. The operation mode change notification packet includes information indicating an increase or a decrease of the operation mode. In FIG. 12A, the operation mode change notification packet includes information indicating that the operation mode is decreased (this information is expressed using “−1” in FIG. 12A). On the other hand, in FIG. 12B, the operation mode change notification packet includes information indicating that the operation mode is increased (this information is expressed using “+1” in FIG. 12B).

Then, the packet processing portion 20 in the post-stage communication device C, after all packets in its own packet buffer have been delivered, changes its own operation mode in accordance with the information included in the operation mode change notification. Then, after the operation of the packet processing portion 20 has stabilized, the post-stage communication device C transmits, to the communication device A, an operation mode change finish packet indicating that the operation mode change has been finished (this information is expressed using “fin” in FIG. 12A and 12B).

The packet processing portion 30 of the communication device A, after having received the operation mode change finish packet from the post-stage communication device C, releases the stoppage of the packet delivery of the input-side packet processing portion of the communication device A. As a result, the packet processing portion 30 of the communication device A can also inform the post-stage communication device of its own load state. This allows changing also the operation mode of the post-stage communication device in response to the information.

According to the operation mode changing device and the communication device disclosed in the present description, when attempting to change the operation mode of the communication device, it is possible to change the operation mode of the communication device while avoiding packet loss and the occurrence of service interruption to maintain communication quality.

While the present invention has been described as related to its embodiments, the present invention is not limited to such specific embodiments, but various modifications and changes may be made therein within its spirit and scope as set off in the appended claims.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A packet processing apparatus for receiving a plurality of incoming packets transmitted from any of the other apparatuses, processing the incoming packets and transmitting the processed packets to any of the other apparatuses, comprising:
a buffer for temporarily storing the incoming packets;
a processing unit for processing the incoming packets stored in the buffer and transmitting the processed packets to any of the other apparatuses; and
a mode controller for controlling an operation mode of the processing unit,
wherein when the mode controller is to change the operation mode of the processing unit, the mode controller generates a request for suspension of transmitting incoming packets to the any of the other apparatuses, confirms that the processing unit has completed processing of all the incoming packets stored in the buffer, changes the operation mode of the processing unit, and generates a request for resume of transmitting incoming packets to the any other apparatuses.

2. The packet processing apparatus according to claim 1, wherein the mode controller generates the request for the resume after confirming a status of the operation mode changed by the mode controller.

3. The packet processing apparatus according to claim 1, wherein the mode controller includes a queue length monitor for monitoring an average queue length of the buffer, and the mode controller includes a mode regulator for controlling the operation mode of the processing unit on the basis of the average queue length monitored by the queue length monitor,
wherein the mode regulator shifts the operation mode to a higher speed operation mode if the average queue length is not less than a first predetermined value, and the mode regulator shifts the operation mode to a lower speed operation mode if the average queue length is not more than a second predetermined value.

4. The packet processing apparatus according to claim 1, wherein the mode controller includes a load monitor for monitoring an traffic average load input into the packet processing unit, and the mode controller includes a mode regulator for controlling the operation mode of the processing unit on the basis of the traffic average load monitored by the load monitor,
wherein the mode regulator shifts the operation mode to a higher speed operation mode if the average load is not less than a first predetermined value, and the mode regulator shifts the operation mode to a lower speed operation mode if the average load is not more than a second predetermined value.

5. The packet processing apparatus according to claim 3, wherein the mode regulator controls an operation clock frequency of the processing unit so as to shift the operation mode.

6. The packet processing apparatus according to claim 4, wherein the mode regulator controls an operation clock frequency of the processing unit so as to shift the operation mode.

7. The packet processing apparatus according to claim 1, wherein the mode regulator controls a power consumption of the processing unit, and when the mode regulator reduces the power consumption, the operation mode is shifted to the lower speed operation mode.

8. The packet processing apparatus according to claim 7, wherein the operation clock frequency and the power consumption is shifted so that the operation mode is shifted.

9. The packet processing apparatus according to claim 1, the packet processing apparatus being incorporated in a communication device including an output port and an input port, the output port including the processing unit, the input port transmitting incoming packets to the processing unit
wherein the mode controller includes a back pressure transmission portion for generating the request for suspension of transmitting incoming packets to the input port.

10. The packet processing apparatus according to claim 1, the packet processing apparatus being incorporated in a communication device including an input port including the processing unit,
wherein the mode controller transmits a pause packet to the any of the other apparatuses transmitting incoming packets so as to generate the request for the suspension of transmitting the incoming packets to the any of the other apparatuses.

11. The packet processing apparatus according to claim 1, wherein the any of the other apparatuses to which the packet processing apparatus transmits the processed packets transmits any of the other apparatuses,
wherein when the mode controller changes the operation mode of the processing unit, the mode controller generates a request for suspension of transmitting the processed packets to the any of the other apparatuses to which the packet processing apparatus transmits the processed packets.

12. A communication apparatus for receiving a plurality of incoming packets transmitted from any of the other apparatuses, processing the incoming packets and transmitting the processed packets to any of the other apparatuses, comprising:
an input port and an output port, the input port including a first processing apparatus for receiving a plurality of incoming packets transmitted from the any of the other apparatuses, processing the incoming packets and transmitting the first processed packets to the output port, the first processing apparatus including:
a first buffer for temporarily storing the incoming packets transmitted from the any of the other apparatuses,
a first processing unit for processing the incoming packets stored in the first buffer and transmitting the first processed packets processed in the first processing unit to the output port, and
a first mode controller for controlling an operation mode of the first processing unit,
wherein when the first mode controller is to change the operation mode of the first processing unit, the first mode controller generates a request for suspension of transmitting incoming packets to the any of the other apparatuses, confirms that the first processing unit has completed processing of all the incoming packets stored in the first buffer, changes the operation mode of the first processing unit, and generates a request for resume of transmitting incoming packets to the any other apparatuses,
the output port including a second processing apparatus for receiving the first processed packets transmitted from the first processing unit, processing the first processed packets and transmitting the second processed packets to the any of the other apparatus, the second processing apparatus including:
a second buffer for temporarily storing the first processed packets transmitted from the first processing unit,
a second processing unit for processing the first processed packets stored in the second buffer and transmitting the second processed packets to the any of the other apparatuses, and
a second mode controller for controlling an operation mode of the second processing unit,
wherein when the second mode controller is to change the operation mode of the second processing unit, the second mode controller generates a request for suspension of transmitting first processed packets to the second processing unit, confirms that the second processing unit has completed processing of all the second processed packets stored in the second buffer, changes the operation mode of the second processing unit, and generates a request for resume of transmitting second processed packets to the any other apparatuses.

13. The communication apparatus according to claim 12, wherein the second mode controller includes a back pressure transmission portion for generating the request for suspension of transmitting first processed packets to the input port.

14. The communication apparatus according to claim 13, wherein the first mode controller transmits a pause packet to the any of the other apparatuses transmitting incoming packets so as to generate the request for the suspension of transmitting the incoming packets to the any of the other apparatuses.
